(19) United States
(12) Patent Application Publication
(10) Pub. No.: US 2008/0158716 A1
(43) Pub. Date: Jul. 3, 2008

(54) Head slider

(75) Inventors: Hiroyuki Kubotera, Kawasaki (JP); Takahiro Imamura, Kawasaki (JP); Toru Watanabe, Kawasaki (JP); Hiroshi Chiba, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/984,587

(22) Filed: Nov. 20, 2007

(30) Foreign Application Priority Data
Dec. 28, 2006 (JP) 2006-354142
Mar. 19, 2007 (JP) 2007-071639

(51) Int. Cl. G11B 21/02

(52) U.S. Cl. 360/75

(57) ABSTRACT

A head slider is configured to fly a head above a recording medium with an air flow. The head slider includes a recessed portion in a surface facing the recording medium. The recessed portion is formed in a shape that does not form a region in which a shear stress due to the air flow is concentrated.

### BACKGROUND OF THE INVENTION

1. Field of the Invention

The present invention generally relates to a head slider for use in a disk device, and particularly relates to a head slider having a recessed portion in its surface to maintain consistent flying characteristics.

2. Description of the Related Art

Increased recording density of magnetic disk devices has caused a demand for reducing the distance between a magnetic disk and a magnetic head flying above the magnetic disk. To reduce the distance between the magnetic head and the magnetic disk, the flying height of the head slider, on which the magnetic head is mounted, needs to be reduced. The flying heights of head sliders of recent magnetic disk devices are reduced to 10 nm or less.

Japanese Patent Laid-Open Publication No. 2004-55127 (corresponding to U.S. Patent Application Publication No. 2004/0012887) discloses a head slider for a magnetic disk device that has recessed portions (also referred to as “grooves”) in the surface thereof for adjusting the flying height and maintaining consistent flying characteristics. When an air flow generated by the rotation of a magnetic disk passes along the recessed portions, an appropriate level of static pressure is generated. With this static pressure, the head slider can stably fly above a magnetic disk while maintaining a predetermined distance from the magnetic disk.

Usually, a lubricant (e.g. PFPE (Perfluoropolyether) oil) is applied on the surface of the magnetic disk in order to reduce friction with the head slider. The lubricant is a liquid having a relatively high viscosity and therefore remains on the surface of the magnetic disk even when the magnetic disk rotates at high speed. That is, the head slider flies above a lubricant coating on the magnetic disk.

If the distance between the head slider and the magnetic disk is reduced, the head slider might come into contact with the lubricant and thus a tiny amount of the lubricant might be transferred onto the surface of the head slider. Also, if vaporized lubricant comes into contact with the surface of the head slider and condenses, the lubricant is attached to the surface of the head slider.

In the case where there is a region into which shear stress due to the air flowing along the surface of the head slider is concentrated, the lubricant is collected into the region.

If the lubricant is accumulated to form a large droplet, the droplet falls from the slider onto the magnetic disk (the lubricant coating). The droplet of the lubricant that has just fallen has a protruding shape on the lubricant coating. When the magnetic disk rotates 360 degrees and the lubricant that has fallen returns to the position of the head slider, the head slider may collide with the lubricant that has fallen. This is because, due to high speed rotation of the magnetic disk and high viscosity of the lubricant, the magnetic disk makes one revolution before the protruding lubricant that has fallen on the magnetic disk becomes flat. If the head slider collides with the lubricant, in the worst case, the head slider can be damaged due to the impact of the collision. This problem is more likely to occur when the distance between the magnetic head and the magnetic disk is short.

### SUMMARY OF THE INVENTION

In view of the foregoing, the present invention is directed to provide a head slider that prevents the lubricant attached to the surface of a head slider from being collected and forming a large droplet.

In an embodiment of the present invention, there is provided a head slider configured to fly a head above a recording medium with an air flow. The head slider comprises a recessed portion in a surface facing the recording medium, wherein the recessed portion is formed in a shape that does not form a region in which a shear stress due to the air flow is concentrated.

In an embodiment of the present invention, there is provided a head slider configured to fly a head above a recording medium with an air flow. The head slider comprises a recessed portion in a surface facing the recording medium; and raised portions in the recessed portion, one in the vicinity of each side face of the head slider. The recessed portion and the raised portions are formed in shapes that do not form a region between the raised portion and a trailing edge of the head slider in which a shear stress due to the air flow is concentrated.

In an embodiment of the present invention, there is provided a head slider configured to fly a head above a recording medium with an air flow. The head slider comprises a recessed portion in a surface facing the recording medium. The recessed portion includes a first recessed portion having a first depth and a second recessed portion having a second depth less than the first depth.

In an embodiment of the present invention, there is provided a head slider configured to fly a head above a recording medium with an air flow. The head slider comprises a recessed portion in a surface facing the recording medium. A bottom face of the recessed portion includes a slope of which a depth gradually decreases toward a trailing edge of the head slider.

In an embodiment of the present invention, there is provided a head slider configured to fly a head above a recording medium with an air flow. The head slider comprises a recessed portion in a surface facing the recording medium. A bottom face of the recessed portion includes a stepped section of which a depth decreases stepwise toward a trailing edge of the head slider.

According to an aspect of the present invention, it is possible to prevent shear stress due to the air flow from being concentrated into a region on the flying surface of the head slider. Accordingly, the lubricant can continuously be forced out in the direction of the trailing edge before the lubricant grows to be a large droplet. It is therefore possible to reduce the influence of the droplet of the lubricant on the flying characteristics of the head slider and to prevent the head slider from being damaged due to collision with the droplet.

### BRIEF DESCRIPTION OF THE DRAWINGS

FIG. 1 is a side view showing a magnetic head slider as an example of a head slider to which an embodiment of the present invention is applicable;

FIG. 2 is a perspective view showing a flying surface of the magnetic head slider of FIG. 1;

FIG. 3 is a vector diagram of shear stresses on the flying surface of FIG. 2;

FIG. 4 is a perspective view showing a flying surface of a head slider according to a first embodiment of the present invention;

FIG. 5 is a vector diagram of shear stresses on the flying surface of FIG. 4;

FIG. 6 is a perspective view showing a flying surface of a head slider according to a second embodiment of the present invention;

FIG. 7 is a perspective view showing a flying surface of a head slider according to a modified embodiment of the second embodiment of the present invention;

FIG. 8 is a perspective view showing a flying surface of a head slider according to a third embodiment of the present invention;

FIG. 9 is a perspective view showing a flying surface of a head slider according to a first modified embodiment of the third embodiment of the present invention;

FIG. 10 is a perspective view showing a flying surface of a head slider according to a second modified embodiment of the third embodiment of the present invention;

FIG. 11 is a perspective view showing a flying surface of a head slider according to a fourth embodiment of the present invention;

FIG. 12 is a perspective view showing a flying surface of a head slider according to a modified embodiment of the fourth embodiment of the present invention;

FIG. 13 is a perspective view showing a flying surface of a head slider according to a fifth embodiment of the present invention;

FIG. 14 is a perspective view showing a flying surface of a head slider according to a modified embodiment of the fifth embodiment of the present invention;

FIG. 15 is a perspective view showing a flying surface of a head slider according to a sixth embodiment of the present invention;

FIG. 16 is a graph showing a relationship between the depth of a second recessed portion and the volume of the lubricant remaining on a bottom face of a second recessed portion;

FIG. 17 is a perspective view showing a flying surface of a head slider according to a seventh embodiment of the present invention;

FIG. 18 is a perspective view showing a flying surface of a head slider according to a first modified embodiment of the seventh embodiment of the present invention;

FIG. 19 is a perspective view showing a flying surface of a head slider according to a second modified embodiment of the seventh embodiment of the present invention;

FIG. 20 is a diagram that illustrates inclination angles of side edges in the flying surface of FIG. 19;

FIG. 21 is a perspective view showing a flying surface of a head slider according to an eighth embodiment of the present invention;

FIG. 22 is a perspective view showing the depth of a bottom face on the flying surface of the head slider of FIG. 19; and

FIG. 23 is a perspective view showing the flying surface of the head slider of FIG. 19 with side pads removed.

### DETAILED DESCRIPTION OF THE PREFERRED EMBODIMENT

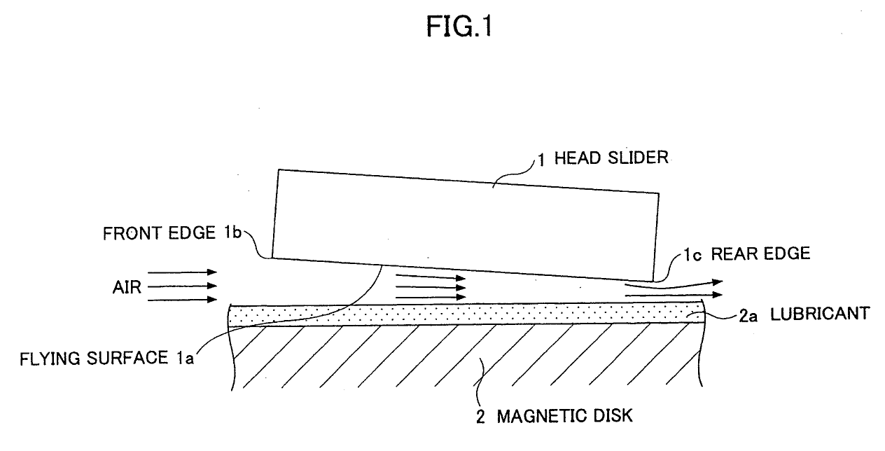

First, a head slider to which an embodiment of the present invention is applicable is described with reference to FIG. 1.

FIG. 1 is a side view showing a magnetic head slider 1 as an example of a head slider to which an embodiment of the present invention is applicable. The magnetic head slider 1 of FIG. 1 is configured to write magnetic signals in and is read magnetic signals from a magnetic disk 2, a recording medium, by using a magnetic head element (not shown) while flying above the magnetic disk 2. The magnetic head slider 1 is as small as about 1 mm in width, 1.2 mm in length, and 100 μm in thickness, for example.

The magnetic head slider 1 includes a flying surface 1a facing the magnetic disk 2. A lubricant coating 2a is formed on the surface of the magnetic disk 2.

The magnetic head slider 1 is configured to fly with an air flow generated by rotation of the magnetic disk 2. While the magnetic head slider 1 flies, a leading edge 1b, the upstream edge in the direction of the air flow, of the flying surface 1a is maintained above a trailing edge 1c, the downstream edge in the direction of the air flow, of the flying surface 1a. That is, the magnetic head slider 1 flies above the magnetic disk 2 while maintaining the trailing edge 1c in the closest proximity to the magnetic disk 2. The magnetic head element is mounted in the vicinity of the trailing edge 1c so as to be held in a position close to the magnetic disk 2 while flying. The trailing edge 1c is also referred to as an outlet because the air flowing along the flying surface 1a flows out from the trailing edge 1c. In the following description, the term “front” indicates the upstream side of the air flow in the axial direction of the head slider; and the term “rear” indicates the downstream side of the air flow in the axial direction of the head slider.

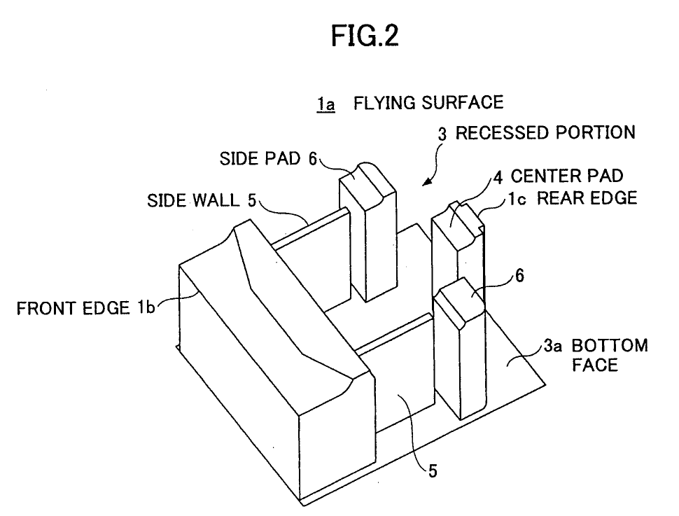

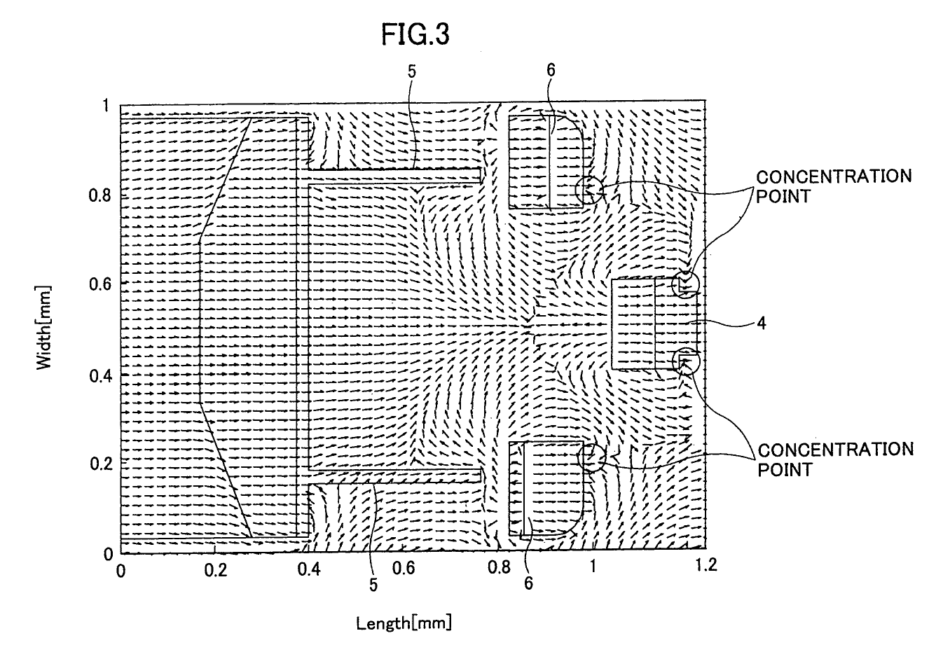

Next, as a reference example, a head slider having a shape such that shear stresses due to an air flow are concentrated on the flying surface is described as a reference example with reference to FIGS. 2 and 3. FIG. 2 is a perspective view showing a flying surface 1a of a head slider having a shape such that shear stresses due to an air flow are concentrated. FIG. 3 is a vector diagram showing shear stresses due to the air flow on the flying surface 1a of FIG. 2.

FIG. 2 is a perspective view showing the flying surface 1a of a magnetic head slider 1. A recessed portion and raised portions for controlling the air flow are formed in the flying surface 1a. More specifically, the raised portions are formed as a result of forming the recessed portion (also referred to as a groove). In FIG. 2, the vertical size (the depth of the recessed portion or the groove) is not drawn to scale but increased. For example, in the case where the magnetic head slider 1 is 1 mm in width and 1.2 mm in length, the depth of the bottom face of the recessed portion or the groove is in a range about 1.5 through 2.0 μm.

No recessed portion is formed at the side of a leading edge 1b on the flying surface 1a of the magnetic head slider 1, while a recessed portion 3 is formed at the side of a trailing edge 1c. The recessed portion 3 has a complex shape as shown in FIG. 2. As a result of forming the recessed portion 3, projecting portions are formed that project from the bottom face 3a of the recessed portion 3. The projecting portions include a center pad 4 (a first raised portion) in the vicinity of the trailing edge 1c at the center in the width direction of the magnetic head slider 1, two side walls 5 extending longitudinally one in the vicinity of each side face of the magnetic head slider 1; and two side pads 6 (second raised portions) at the rear sides of the corresponding side walls 5.

A magnetic head element (not shown) is mounted near the surface of the center pad 4 (the first raised portion) in the vicinity of the trailing edge 1c. The side pads (the second raised portions) 6 are provided one in the vicinity of each side face of the magnetic head slider 1 such that the magnetic head slider 1 maintains a stable flying position. The side walls 5 are provided for defining a space in the substantial center of the magnetic head slider 1. The air that has flowed into this space generates a negative pressure in the space, which produces an appropriate force that presses the magnetic head slider 1 toward the magnetic disk 2.

In the magnetic head slider 1 including the flying surface 1a with the shape as described above, when the air flows from the leading edge 1b side, shear stresses due to the air flow are applied to the flying surface 1a. In FIG. 3, the shear stresses are represented as vectors. The arrows of FIG. 3 indicate the vectors representing the shear stresses. The directions of the arrows correspond to the directions of the shear stresses due to the air flow.

In FIG. 3, the regions enclosed by circles are pointed at by the arrows from all directions. In these regions, the shear stresses due to the air flow are concentrated from substantially all directions. The regions where the shear stresses are concentrated from substantially all directions are hereinafter referred to as concentration points. If a concentration point is formed, a tiny amount of lubricant that has been carried to the concentration point remains there. As the amount of the lubricant that has accumulated and remained at the concentration point increases over time, the lubricant grows to be a big drop.

The drop of the lubricant adversely affects the flying characteristics of the magnetic head slider 1. In the worst case, the drop on the magnetic head slider 1 falls onto the disk and collides with the magnetic head slider 1, and thus may damage the magnetic head slider 1. In the magnetic head slider 1 shown in FIG. 2, concentration points are easily generated especially behind the side pads 6.

In an embodiment of the present invention, a recessed portion is formed in a shape that prevents a concentration point from being generated on a flying surface of a head slider.

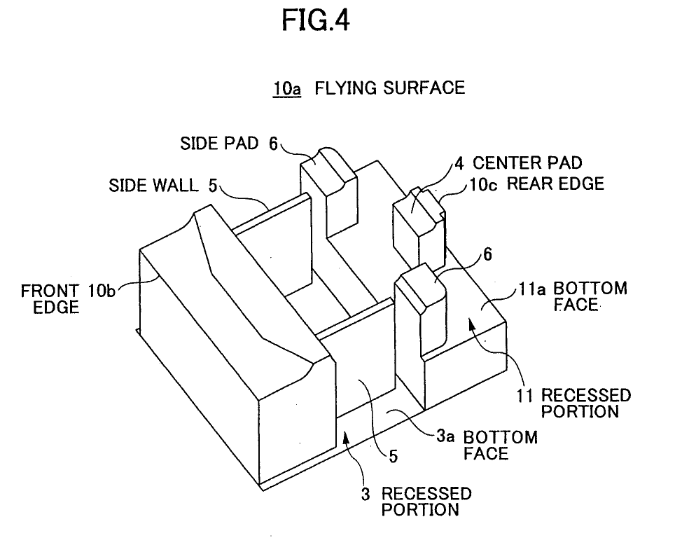

FIG. 4 is a perspective view showing a flying surface 10a of a head slider according to a first embodiment of the present invention. The flying surface 10a of the head slider of the first embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In this embodiment, the recessed portion 3 (the first recessed portion) is formed at the front side of a line connecting the front faces of two side pads 6, while the bottom face 11a of the recessed portion 11 (the second recessed portion) extends across the entire portion at the rear side of the line connecting the front faces of the two side pads 6. That is, the bottom face 11a of the recessed portion 11 is formed to surround the side pads 6 and a center pad 4. In other words, the center pad 4 and the side pads 6 are disposed within the recessed portion 11 (the second recessed portion) and project from the bottom face 11a.

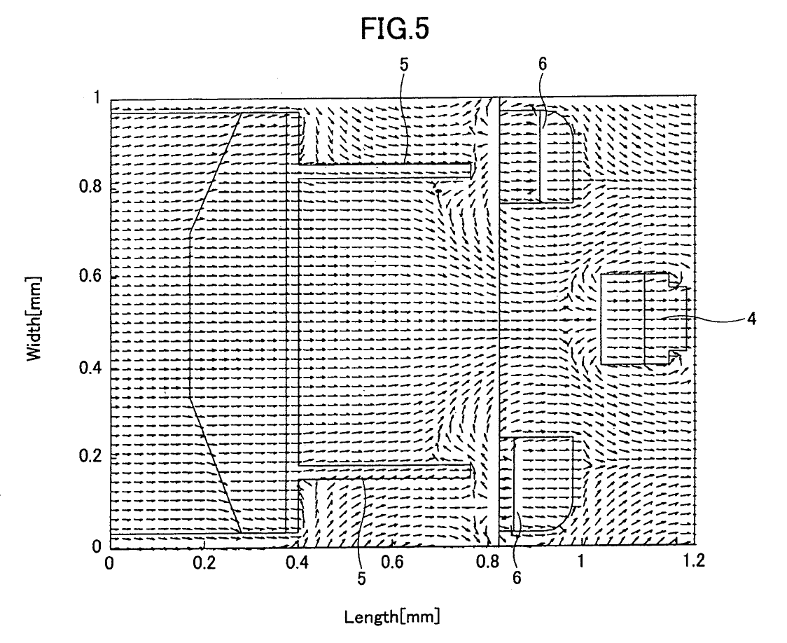

When the air flows from a leading edge 10b of the flying surface 10a toward a trailing edge 10c, shear stresses due to the air flow are applied to the flying surface 10a. In FIG. 5, the shear stresses are represented as vectors. Unlike the example shown in FIG. 2, concentration points as shown in FIG. 2 are not generated behind the center pad 4 or behind the side pads 6. That is, according to this embodiment, the recessed portion having two depths includes the recessed portion 11, which includes the bottom face 11a of the lesser depth extending rearward from the side pads 6. This configuration prevents concentration points from being generated behind the center pad 4 and the side pads 6.

As is obvious from FIG. 5 showing the shear stresses, the recessed portion with the reduced depth prevents formation of concentration points behind obstacles, such as the side pads 6, to the air flow. In other words, reducing the heights of the obstacles prevents formation of concentration points. However, because the depth of the recessed portion relates to negative pressure to be produced by the recessed portion, the recessed portion needs to have a depth sufficient to generate appropriate negative pressure. In consideration of this, in the present embodiment the recessed portion has two depths, in which the recessed portion 3 (the first recessed portion) of the greater depth produces the required negative pressure. Meanwhile, the recessed portion 11 (the second recessed portion) of the lesser depth is formed in the area where the obstacles such as the side pads 6 are disposed, thereby preventing formation of concentration points.

It is to be noted that, in the flying surface 10a shown in FIG. 4, the bottom face 11a of the recessed portion 11 extends to the trailing edge 10c of the flying surface 10a and thus substantially defines the trailing edge of the head slider.

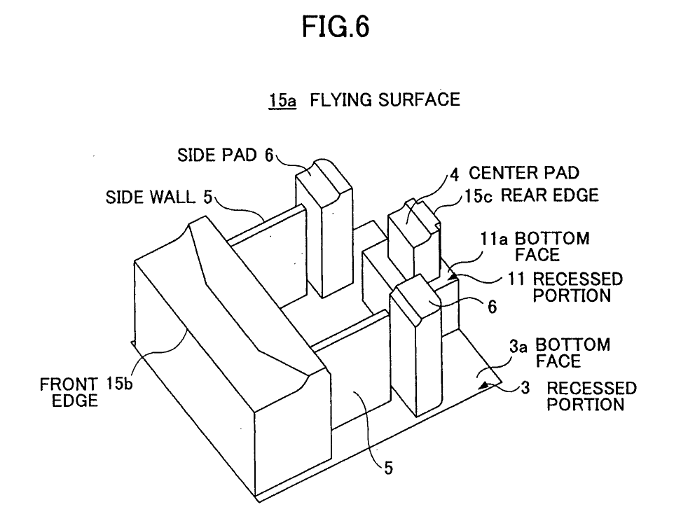

FIG. 6 is a perspective view showing a flying surface 15a of a head slider according to a second embodiment of the present invention. Similar to the first embodiment, the flying surface 15a of the head slider of the second embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In this embodiment, the bottom face 11a of the recessed portion 11 (the second recessed portion) extends only around a center pad 4. That is, the bottom face 11a of the recessed portion 11 is formed to surround the center pad 4. In other words, the center pad 4 is disposed within the recessed portion 11 (the second recessed portion) and projects from the bottom face 11a.

When air flows from a leading edge 15b of the flying surface 15a toward a trailing edge 15c, concentration points as shown in FIG. 2 are not generated behind the center pad 4. That is, in this embodiment, the bottom face 11a of the recessed portion 11 is formed to surround the center pad 4, thereby preventing concentration points from being generated behind the center pad 4.

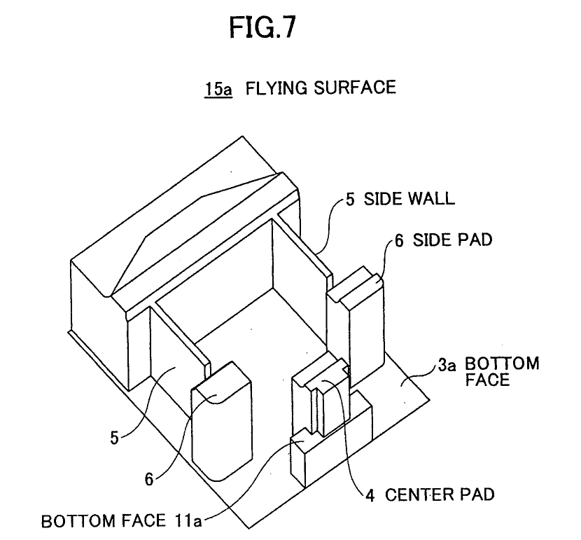

It is to be noted that even in the case where the bottom face 11a of the recessed portion 11 does not surround the entire circumference of the center pad 4 but surrounds half or greater than half the circumference of the center pad 4 at the rear side thereof as shown in FIG. 7, it is possible to prevent the formation of a concentration point behind the center pad 4.

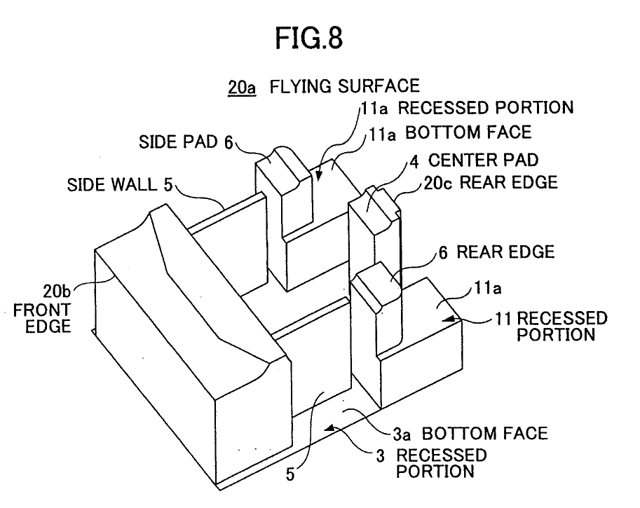

FIG. 8 is a perspective view showing a flying surface 20a of a head slider according to a third embodiment of the present invention. The flying surface 20a of the head slider of the third embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In this embodiment, the bottom face 11a of the recessed portion 11 (the second recessed portion) extends only around each side pad 6. That is, the bottom face 11a of the recessed portion 11 is formed to surround each side pad 6. In other words, the side pads 6 are disposed within the recessed portion 11 (the second recessed portion) and project from the bottom face 11a.

When air flows from a leading edge 20b of the flying surface 20a toward a trailing edge 20c, concentration points as shown in FIG. 2 are not generated behind the side pads 6. That is, in this embodiment the recessed portion having two depths includes the recessed portion 11, which includes the bottom face 11a of the lesser depth surrounding each of the side pads 6. This configuration prevents concentration points from being formed behind the side pads 6.

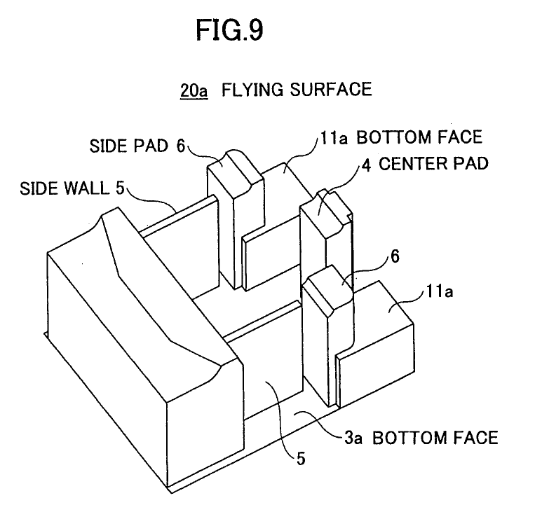

It is to be noted that even in the case where the bottom face 11a of the recessed portion does not surround the entire circumference of each side pad 6 but surrounds half or greater than half the circumference of each side pad 6 at the rear side thereof as shown in FIG. 9, it is possible to prevent the formation of the concentration points behind the side pads 6.

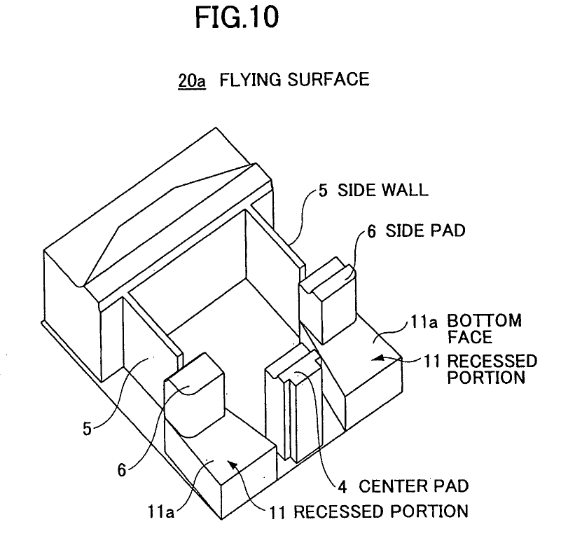

As shown in FIG. 10, the bottom face 11a of the recessed portion 11 surrounding each side pad 6 may have opposing inner side edges each inclined relative to the center axis of the head slider such that the width of the bottom face 11a gradually increases rearward from the front face of each side pad 6. A head slider moves above a disk in the radial direction through rotation of an arm attached to the head slider. Therefore, the center axis of the head slider is not always aligned with the tangential direction of the disk, and there is a so-called a skew angle between the tangential direction of the disk and the center axis of the head slider. Accordingly, the direction of the air flowing along the flying surface of the head slider is inclined at the skew angle. More specifically, the air does not always flows from the direct front (the direction perpendicular to the leading edge) and may flow from the direction inclined at the skew angle with respect to the direction perpendicular to the leading edge (i.e. the longitudinal axis of the head slider).

In the example shown in FIG. 10, each of the longitudinal edges (the edges extending from the inner front corners of the corresponding side pads 6) of the bottom face 11a of the recessed portion 11 is inclined at the maximum skew angle or greater with respect to the longitudinal axis of the head slider such that the bottom face 11a is present behind the side pads 6 in the direction of the air flowing through the head slider.

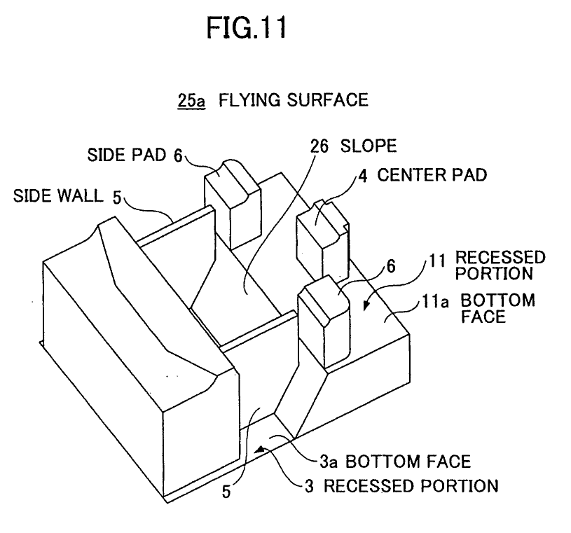

FIG. 11 is a perspective view showing a flying surface 25a of a head slider according to a fourth embodiment of the present invention. The flying surface 25a of the head slider of the fourth embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In this embodiment, a slope 26 is formed between the bottom face 11a of the recessed portion 11 (the second recessed portion) and the bottom face 3a of the recessed portion 3 (the first recessed portion). The air flowing along the bottom face 3a of the first recessed portion 3 flows along the slope 26 onto the bottom face 11a of the second recessed portion 11. That is, the slope 26 makes the air flow smoothly from the first recessed portion 3 to the second recessed portion 11, thereby preventing turbulence and concentration of the air.

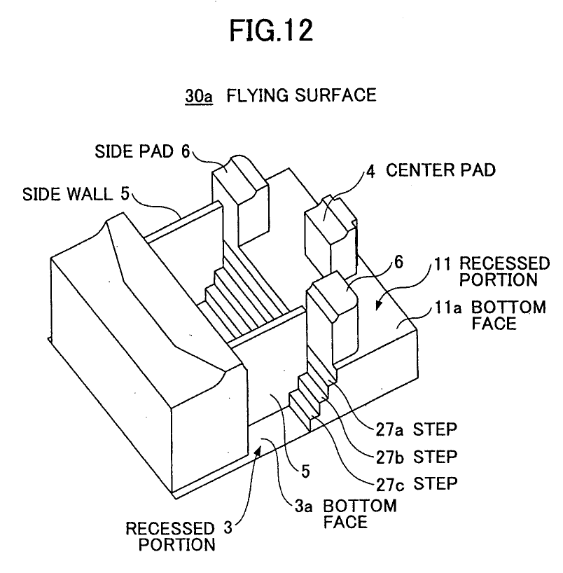

In the present embodiment the slope 26 is provided to prevent turbulence and concentration of the air flowing from the first the first recessed portion 3 to the second recessed portion 11. Alternatively, as shown in a flying surface 30a of FIG. 12, steps 27a, 27b, and 27c forming a stair-like structure may be provided between a bottom face 11a of a recessed portion 11 (a second recessed portion) and a bottom face 3a of a recessed portion 3 (a first recessed portion). If the height difference between the adjacent steps is small, the steps 27a, 27b, and 27c can bring about the same advantages as the slope 26.

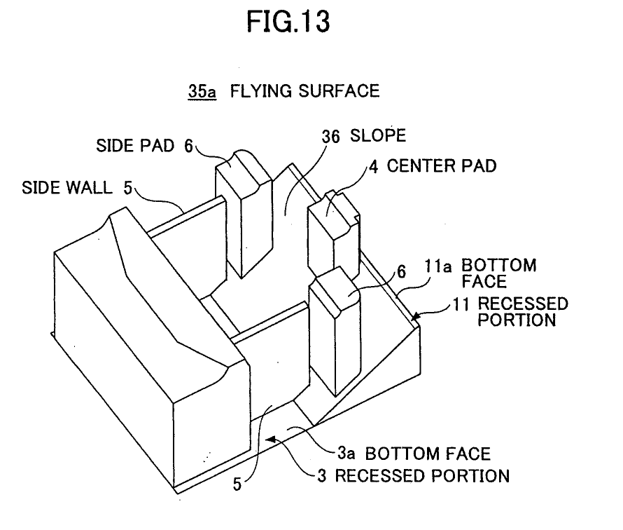

FIG. 13 is a perspective view showing a flying surface 35a of a head slider according to a fifth embodiment of the present invention. The flying surface 35a of the head slider of the fifth embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In this embodiment, the bottom face 11a of the recessed portion (the second recessed portion) corresponds to a small area at the rear side of a center pad 4; and a slope 36 is formed between the bottom face 11a of the recessed portion 11 and the bottom face 3a of the recessed portion 3 formed at the front side of side pads 6. The air flowing along the bottom face 3a of the first recessed portion 3 flows along the slope 26 onto the bottom face 11a of the second recessed portion 11. That is, the slope 36 makes the air flow smoothly from the first recessed portion 3 to the second recessed portion 11, thereby preventing turbulence and concentration of the air. The slope 36 is higher at the rear side of the side pads 6 than the front side of the side pads 6, which prevents concentration of the air behind the side pads 6.

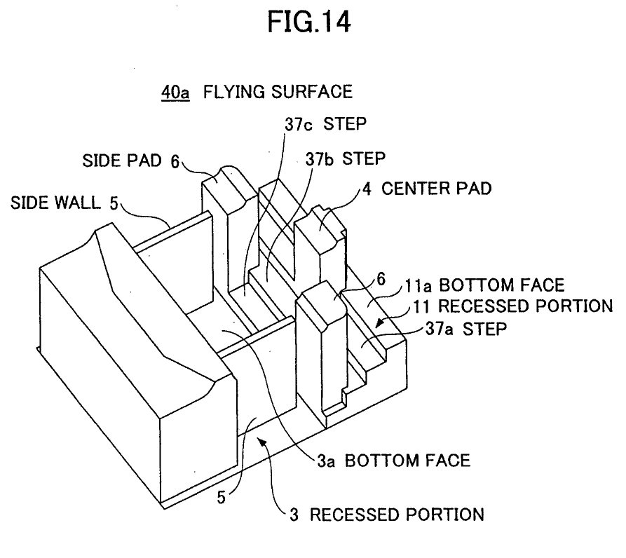

In the present embodiment the slope 36 is provided to prevent turbulence and concentration of the air flowing from the first recessed portion 3 to the second recessed portion 11. Alternatively, as shown in a flying surface 40a of FIG. 14, steps 37a, 37b, and 37c forming a stair-like structure may be provided between a bottom face 11a of a recessed portion 11 (a second recessed portion) and a bottom face 3a of a recessed portion 3 (a first recessed portion). If the height difference between the adjacent steps is small, the steps 37a, 37b, and 37c can bring about the same advantages as the slope 36.

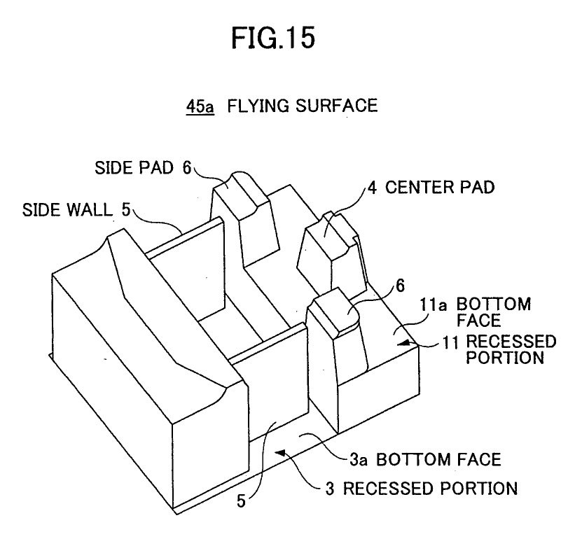

FIG. 15 is a perspective view showing a flying surface 45a of a head slider according to a sixth embodiment of the present invention. The flying surface 45a of the head slider of the sixth embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In the present embodiment, the front, rear, and side faces of a center pad 4 and the rear and side faces of each side pad 6 are tilted, thereby preventing turbulence of the air in the vicinity of the center pad 4 and the side pads 6 and preventing concentration of shear stress due to the air flow.

The configuration of this embodiment, i.e., sloping the front, rear, and side faces of the center pad 4 and the rear and side faces of the side pads 6, is applicable to the above-described first through fifth embodiments and their modified embodiments.

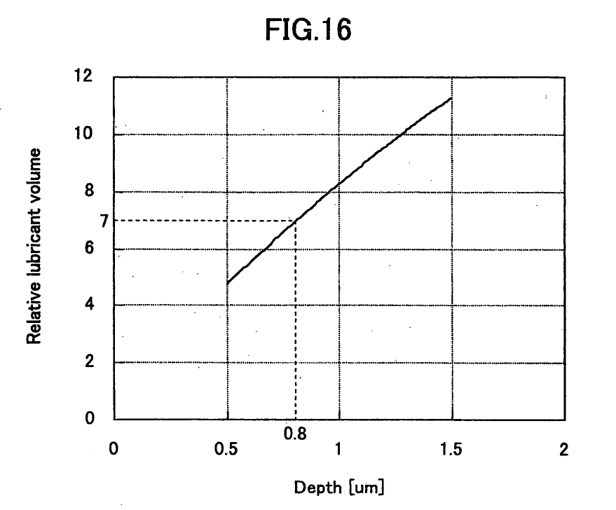

In the above embodiments the provision of the second recessed portion 11, which has the lesser depth than the first recessed portion 3, prevents concentration of shear stress due to the air flow. The inventors of the present invention examined the volume of the lubricant remaining on a bottom face 11a of a second recessed portion 11 of a head slider having about a 1 mm width and a 1.2 mm length while varying the depth of a first recessed portion 3 in the range from about 0.5 to about 1.5 μm. FIG. 16 is a graph showing a relationship between the depth of the second recessed portion 11 and the volume of the lubricant remaining on the bottom face 11a of the second recessed portion.

As shown in FIG. 16, the deeper the recessed portion 11, the less the volume of the lubricant remaining on the bottom face 11a of the recessed portion 11 becomes. If the recessed portion 11 is too deep, the advantageous effects of the recessed portion 11 are reduced. It was found from the study of the inventors that, when the volume of the remaining lubricant is 7 or less, the lubricant does not adversely affect the flying characteristics. It was also found that, based on the graph of FIG. 16, the depth of the recessed portion 11 is preferably 0.8 μm or less.

Other embodiments of the present invention are described below.

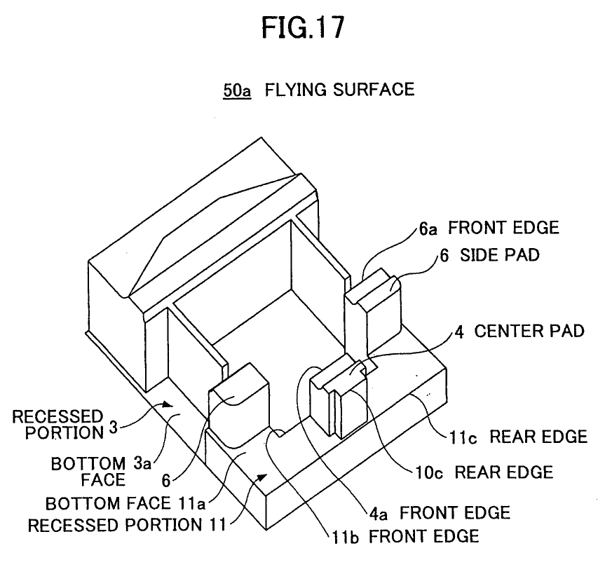

FIG. 17 is a perspective view showing a flying surface 50a of a head slider according to a seventh embodiment of the present invention. The flying surface 50a of the head slider of the seventh embodiment of the present invention includes a recessed portion 3 (a first recessed portion) and a recessed portion 11 (a second recessed portion). The depth of a bottom face 11a of the recessed portion 11 is less than the depth of a bottom face 3a of the recessed portion 3. In other words, a recessed portion is formed that includes the first and second recessed portions of two different depths.

In the present embodiment, a leading edge 11b of the bottom face 11a is located at the rear side of leading edges 6a of side pads 6.

That is, the leading edge 11b of the bottom face 11a extending between the opposing side pads 6 is located between the leading edges 6a of the side pads 6 and a trailing edge 10c of a center pad 4. The trailing edge of the head slider corresponds to the trailing edge 10c of the center pad 4. The trailing edge 10c of the center pad 4 is substantially aligned with the trailing edge 11c of the bottom face 11a of the recessed portion 11.

According to the present embodiment, the bottom face 3a of the recessed portion 3 extends rearward beyond the leading edges 6a of the side pads 6. That is, the area of the bottom face 3a is increased, so that the negative pressure to be generated by the recessed portion 3 can be increased. It is therefore possible to maintain the flying height of the head slider at a reduced level and thus make the head slider stably fly.

In the example shown in FIG. 17, although the leading edge 11b of the bottom face 11a is aligned with the leading edge 4a of the center pad 4, the leading edge 11b of the bottom face 11a may alternatively be located between the leading edges 6a of the side pads 6 and the leading edge 4a of the center pad 4.

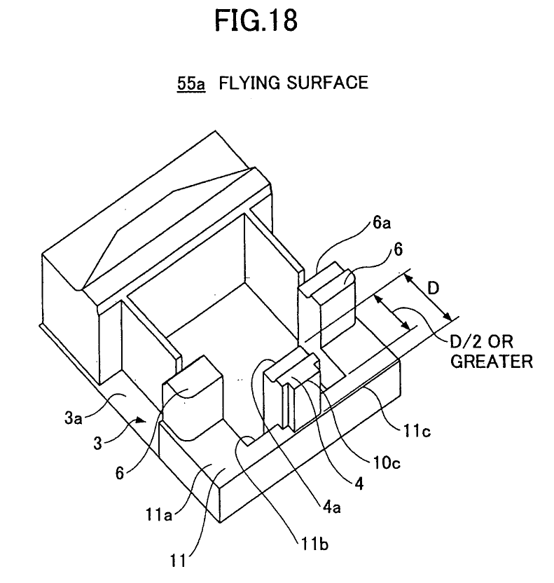

As shown in a flying surface 55a of FIG. 18, a leading edge 11b of a bottom face 11a may be located at the rear side of a leading edge 4a of a center pad 4. In this case, the leading edge 11b of the bottom face 11a may preferably be spaced apart from the leading edge 4a of the center pad 4 toward the trailing edge 10c of the center pad 4 by half or greater than half the distance (a distance D) between the leading edge 4a of the center pad 4 and the trailing edge 10c. If the leading edge 11b is shifted further rearward to eliminate the bottom face 11a between the opposing side pads 6, a bottom face 3a of a recessed portion 3 forms a part of the rear end of the head slider, from which the air flows out from the outlet. Thus, the negative pressure to be generated by the recessed portion 3 is reduced. It is therefore preferable that the trailing edge 11c of the bottom face 11a of the recessed portion 11 form the trailing edge of the head slider (excluding the trailing edge of the head slider defined by the trailing edge 10c of the center pad 4).

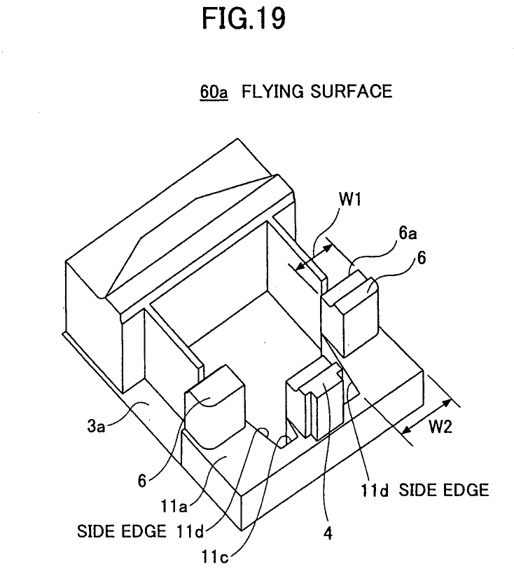

Further, as shown in a flying surface 60a of FIG. 19, opposing inner side edges lid of a bottom face 11a may preferably be inclined with respect to the longitudinal axis of a head slider. With this configuration, the bottom face 11a has a width W1 at a leading edge 6a of side pads 6 and a width W2, greater than the width W1, at a trailing edge 11c of the bottom face 11a. Since the side edges lid are inclined as described above, even if the head slider is slightly inclined with respect to the direction of the air flow, it is possible to prevent concentration points from being generated behind the side pads 6.

A head slider mounted in a magnetic disk device or the like moves above a disk in the radial direction through rotation of an arm attached to the head slider. Therefore, the center axis of the head slider is not always aligned with the tangential direction of the disk, and there is a so-called skew angle between the tangential direction of the disk and the center axis of the head slider. Accordingly, the direction of the air flowing along the flying surface of the head slider is inclined at the skew angle. More specifically, the air does not always flow from the direct front (the direction perpendicular to the leading edge of the head slider) and may flow from the direction inclined at the skew angle with respect to the direction perpendicular to the leading edge (i.e. the longitudinal axis of the head slider). The skew angle at the time the head slider is on the outermost periphery of the disk is hereinafter referred to as an outer skew angle, while the skew angle at the time the head slider is on the innermost periphery of the disk is hereinafter referred to as an inner skew angle.

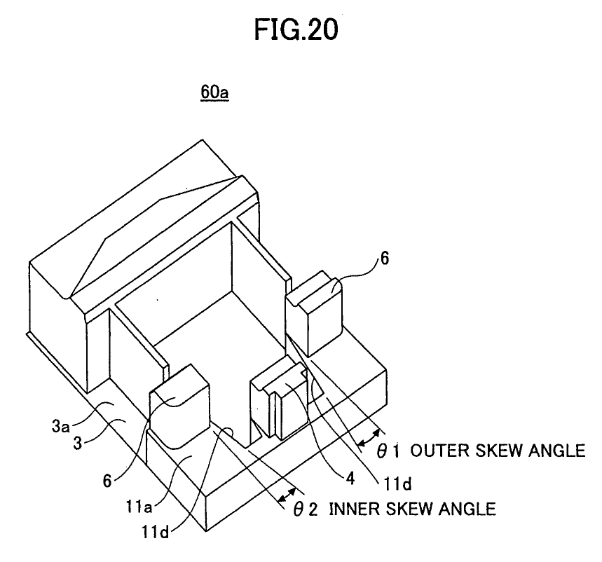

In the example shown in FIG. 20, side edges lid (the edges extending from the inner front corners of the corresponding side pads 6) are inclined respectively at the skew angles or greater with respect to the longitudinal axis of a head slider such that the bottom face 11a is present behind the side pads 6 in the direction of the air flowing through the head slider. In FIG. 20, an angle θ1 corresponds to the outer skew angle, and an angle θ2 corresponds to the inner skew angle. It is preferable that the inclination angles of side edges lid be equal to the outer skew angle or greater and the inner skew angle or greater, respectively, as described above. However, because the increased inclination angles reduce the area of a bottom face 3a of a recessed portion 3, it is more preferable that the inclination angles of the side edges lid be equal to the outer skew angle and the inner skew angle, respectively.

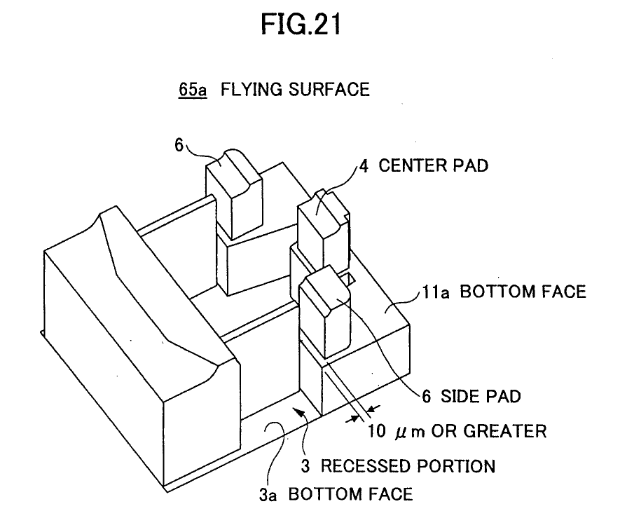

An eighth embodiment of the present invention is described below with reference to FIG. 21. FIG. 21 is a perspective view showing a flying surface 65a of a head slider according to an eighth embodiment of the present invention.

In this embodiment, as shown in FIG. 21, a bottom face 11a includes, although small, portions extending at the front side and lateral sides of each of a center pad 4 and side pads 6. This is to prevent manufacturing defects of the flying surface 65a. As the elements of the flying surface 65a are formed by etching using plural masks, a variation of the mask positions can cause misalignment between the portion higher than a bottom face 11a and a portion lower than the bottom face 11a. For example, in the case where the portions higher than the bottom face 11a, i.e., the center pad 4 and the side pads 6, are formed by etching using a first mask and then the portion lower than the bottom face 11a, i.e., a bottom face 3a of a recessed portion 3, is formed using a second mask, the positions of the first mask used for forming the portions higher than the bottom face 11a and the second mask used for forming the portion lower than the bottom face 11a might not be exactly aligned. If the second mask is misaligned with the first mask, the center pad 4 and the side pads 6 may be unexpectedly etched, or the bottom face 11a around the center pad 4 and the side pads 6 may become larger than expected.

The flying characteristics of the head slider vary depending on the shape of the entire flying surface. Especially, changes in the shape at the front sides of the side pads 6 and at the front side of the center pad 4 largely affect the flying characteristics. In this embodiment, the flying surface is formed such that the bottom face 11a includes portions extending at the front side of each side pad 6 and at the front side of the center pad 4, thereby preventing the flying characteristics from varying due to the positioning accuracy of the masks.

More specifically, the flying surface 65a is formed such that the leading edge of the bottom face 11a extending along the side pads 6 and along the center pad 4 is spaced apart forward by 10 μm or greater from the leading edges of the side pads 6 and the center pad 4. With this configuration of the flying surface, even if the masks are misaligned with each other, the bottom face 11a is present at the front side of each side pad 6 and at the front side of the center pad 4. It is therefore possible to reduce changes from the desired flying characteristics.

This configuration of the flying surface 65a with the bottom face 11a including the portions extending at the front and lateral sides of each of the side pads 6 and the center pad 4 is applicable to other embodiments of the present invention.

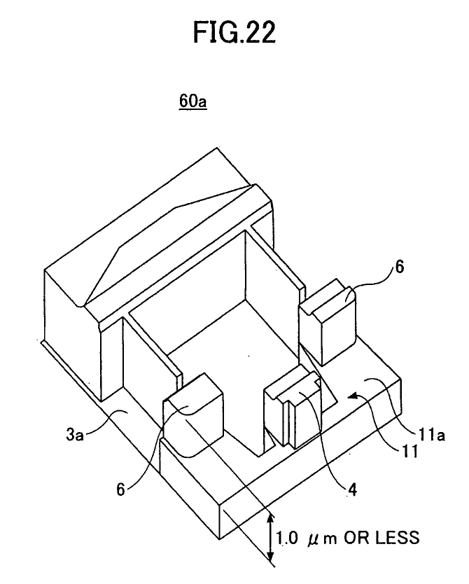

In the seventh and eighth embodiments, as shown in FIG. 22, the depth of the bottom face 11a of the recessed portion 11 is preferably 1.0 μm or less. Although FIG. 22 shows the flying surface 60a of the head slider of FIG. 19 as an example of one in which the depth of the bottom face 11a of the recessed portion 11 is 1.0 μm or less, it is preferable as well, for the flying surfaces having other configurations, that the depth of the bottom face 11a of the recessed portion 11a be 1.0 μm or less.

In the seventh and eighths embodiments and their modified embodiments, the second recessed portion 11 having the depth less than the first recessed portion 3 is formed to prevent concentration of shear stress due to the air flow. For example, in the case where a head slider of about 1 mm width and 1.2 mm length has a first recessed section 3 with a depth in a range of 1.5-2.0 μm, the depth of a second recessed portion 11 is preferably 1.0 μm or less. In the foregoing embodiments, it is possible to maintain consistent flying characteristics by increasing the area of the bottom face 11a of the recessed portion 11. Therefore, even if the recessed portion 11 is as deep as about 1.0 μm, it is possible to prevent concentration of shear stress due to the air flow and to reduce the volume of the lubricant remaining on the surface 11a of the recessed portion 11 while maintaining consistent flying characteristics.

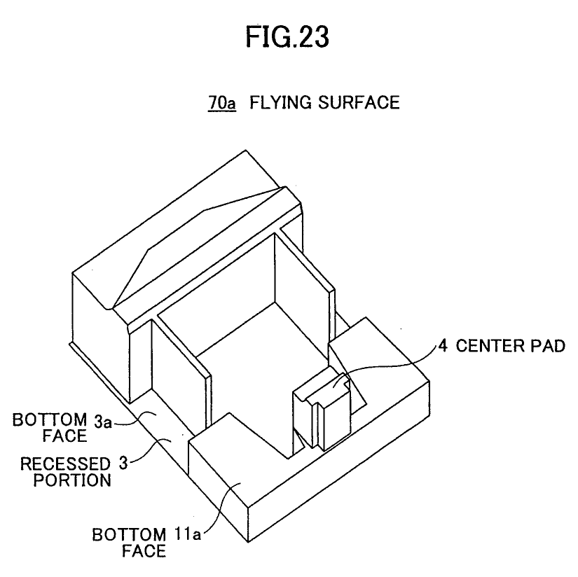

Although in the foregoing embodiments the side pads 6 are provided such that the head slider maintains a stable flying position, the side pads 6 do not necessarily have to be provided. Especially, as shown in FIG. 23, in the case where the area of a bottom face 3a of a recessed portion 3 is relatively large, it is possible to maintain consistent flying characteristics. Accordingly, the head slider can maintain a stable flying position even without the side pads 6. A flying surface 70a shown in FIG. 23 has the same configuration as the flying surface 60a shown in FIG. 19 except for not having side pads 6.

The present application is based on Japanese Priority Application No. 2006-354142 filed on Dec. 28, 2006, and Japanese Priority Application No. 2007-071639 filed on Mar. 19, 2007, with the Japanese Patent Office, the entire contents of which are hereby incorporated by reference.

What is claimed is:

1. A head slider configured to fly a head above a recording medium with an air flow, the head slider comprising:
a recessed portion in a surface facing the recording medium;
wherein the recessed portion is formed in a shape that does not form a region in which a shear stress due to the air flow is concentrated.

2. A head slider configured to fly a head above a recording medium with an air flow, the head slider comprising:
a recessed portion in a surface facing the recording medium; and
raised portions in the recessed portion, one in the vicinity of each side face of the head slider;
wherein the recessed portion and the raised portions are formed in shapes that do not form a region between the raised portion and a trailing edge of the head slider in which a shear stress due to the air flow is concentrated.

3. A head slider configured to fly a head above a recording medium with an air flow, the head slider comprising:
a recessed portion in a surface facing the recording medium;
wherein the recessed portion includes a first recessed portion having a first depth and a second recessed portion having a second depth less than the first depth.

4. The head slider as claimed in claim 3, wherein the second recessed portion is formed around a first raised portion on which a head element is to be mounted.

5. The head slider as claimed in claim 4, wherein a bottom face of the second recessed portion surrounds half or greater than half a circumference of the first raised portion at a rear side thereof.

6. The head slider as claimed in claim 3, wherein the second recessed portion is disposed between a trailing edge of the head slider and each of second raised portions, the second raised portions being formed one in the vicinity of each side face of the head slider.

7. The head slider as claimed in claim 6, wherein a bottom face of the second recessed portion surrounds half or greater than half a circumference of each of the second raised portions at rear sides thereof.

8. The head slider as claimed in claim 6, wherein a width of the bottom face of the second recessed portion increases rearward from the vicinity of each of the second raised portions.

9. The head slider as claimed in claim 3, wherein a bottom face of the second recessed portion defines a trailing edge of the head slider.

10. The head slider as claimed in claim 3, wherein a slope is formed between the first recessed portion and the second recessed portion.

11. The head slider as claimed in claim 3, wherein plural steps are formed between the first recessed portion and the second recessed portion.

12. The head slider as claimed in claim 3,
wherein a first raised portion, on which a head element is to be mounted, projecting from a bottom face of the second recessed portion is formed;
second raised portions projecting from the bottom face of the second recessed portion are formed one in the vicinity of each side face of the head slider; and
side faces of the first raised portion and side faces of each of the second raised portions are tilted.

13. A head slider configured to fly a head above a recording medium with an air flow, the head slider comprising:
a recessed portion in a surface facing the recording medium;
wherein a bottom face of the recessed portion includes a slope of which a depth gradually decreases toward a trailing edge of the head slider.

14. A head slider configured to fly a head above a recording medium with an air flow, the head slider comprising:
a recessed portion in a surface facing the recording medium;
wherein a bottom face of the recessed portion includes a stepped section of which a depth decreases stepwise toward a trailing edge of the head slider.

15. The head slider as claimed in claim 6,
wherein a leading edge of a bottom face of the second recessed portion extending between the second raised portions is located between the trailing edge of the head slider and leading edges of the second raised portions; and
a trailing edge of the bottom face of the second recessed portion defines the trailing edge of the head slider.

16. The head slider as claimed in claim 15,
wherein a first raised portion, on which a head element is to be mounted, is formed in the vicinity of the trailing edge of the head slider; and
the leading edge of the bottom face of the second recessed portion extending between the second raised portions is aligned with a leading edge of the first raised portion.

17. The head slider as claimed in claim 15, wherein a first raised portion, on
which a head element is to be mounted, is formed in the vicinity of the trailing edge of the head slider; and
the leading edge of the bottom face of the second recessed portion extending between the second raised portions is spaced apart from a leading edge of the first raised portion toward a trailing edge of the first raised portion by half or greater than half a distance between the trailing edge and the leading edge of the first raised portion.

18. The head slider as claimed in claim 17, wherein each of inner side edges of the bottom face of the second recessed portion is located between the second raised portions and is inclined at a predetermined angle with respect to a longitudinal axis of the head slider such that a width of the bottom face of the second recessed portion at the rear side of each of the second raised portions gradually increases rearward.

19. The head slider as claimed in claim 18, wherein the predetermined angle is equal to or greater than a skew angle of a disk device in which the head slider is to be mounted.

20. The head slider as claimed in claim 15, wherein the leading edge of the second recessed portion extending along a leading edge of each of the second raised portions is spaced apart from the leading edge of each of the second raised portions toward a leading edge of the head slider by a predetermined distance.

21. The head slider as claimed in claim 4, wherein a bottom face of the second recessed portion does not include any raised portions other than the first raised portion.
